(19) United States
(12) Patent Application Publication
(10) Pub. No.: US 2026/0298387 A1
(43) Pub. Date: Oct. 1, 2026

(54) RIVETABLE PIPE JOINT, ASSEMBLY AND MOUNTING METHOD THEREOF

(71) Applicant: PEM (China) Co., Ltd., Kunshan (CN)

(72) Inventors: Qiang Sun, Novi, MI (US); Shengbao Cai, Kunshan (CN); Ming Zhang, Kunshan (CN); Dong Liu, Kunshan (CN); Dapeng Duan, Kunshan (CN); Zhiqiang Huang, Kunshan (CN)

(21) Appl. No.: 19/158,908

(22) PCT Filed: Jun. 30, 2025
(86) PCT No.: PCT/CN2025/105781

§ 371 Date: Aug. 22, 2025

(30) Foreign Application Priority Data
Dec. 19, 2024 (CN) 202411877546.5
May 28, 2025 (CN) 202510699774.6

(51) Int. Cl. F16L 41/14; F16B 37/06; F16L 13/16

(52) U.S. Cl. CPC F16L 41/14; F16B 37/062; F16L 13/16

(57) ABSTRACT

A pipe joint adapted to be riveted to a member to be riveted is provided, including: a main body having a through hole, which includes: a connecting portion including a proximal end for connecting a pipe fitting and a distal end relatively away from the proximal end; a deformable portion having a proximal end of connected to the distal end of the connecting portion, wherein an outer diameter of the distal end of the connecting portion is greater than that of the deformable portion, and the deformable portion can radially outwards protrude under an external force, to cooperate with the distal end of the connecting portion to clamp the member to be riveted; and a limiting portion, the connecting portion is connected to the deformable portion through the limiting portion, an outer diameter of the limiting portion is greater than that of the deformable portion and less than that of the distal end of the connecting portion, and the limiting portion is configured such that, when the deformable portion is inserted into an opening of the member during riveting the pipe joint to the member, the limiting portion abuts against the opening to restrain the pipe joint from rotating around an axis extending along the through hole.

### FIELD OF THE INVENTION

The present application relates to the field of fluid conveying systems, and more particularly, to a pipe joint adapted to be riveted, and an assembly and a mounting method thereof.

### BACKGROUND

A fluid conveying system (such as a liquid cooling system) is widely used in many fields such as data centers, electronic equipment, automobiles, and aerospace. In such a system, a pipe joint serves as a key component for connecting a pipeline to a fluid channel, and its structural design directly affects the heat dissipation efficiency, operation reliability, and mounting and maintenance costs of the system.

At present, common mounting modes for the pipe joint mainly include welding and hot drilling. Although the welding mode provides good sealing performance, the mounting process is complex, requires a high level of operator skill, and is highly dependent on a construction environment. Consequently, manufacturing and mounting costs are significantly increased, which limits promotion of the welding mode in large-scale applications. Although the hot drilling process can enable quick connection on some thermoplastic materials, this process also has many shortcomings: for example, a limited range of applicable materials, making it difficult to apply the hot drilling process to metals or composite materials; structural deformation easily caused by local heating, which affects the connection strength and the sealing performance; and sensitive process parameters, which easily leads to a mounting failure due to operation deviations. In addition, the hot drilling connection mode is not conducive to later maintenance and repeated assembling, and has particular safety hazards.

Therefore, there is an urgent need for a pipe joint that is easy to mount, compact in structure, and reliable in connection and has low maintenance costs, and a mounting method of the pipe joint, so as to meet higher requirements of a modern fluid conveying system for performance, efficiency, and safety.

### SUMMARY

One objective of the present application is to provide an improved pipe joint adapted to be riveted, and an assembly and a mounting method thereof.

In one aspect of the present application, a pipe joint adapted to be riveted to a member to be riveted, including: a main body having a through hole extending therethrough, and the main body comprises: a connecting portion, wherein the connecting portion comprises a proximal end for connecting a pipeline and a distal end relatively away from the proximal end; a deformable portion, a proximal end of which is connected to the distal end of the connecting portion, wherein an outer diameter of the distal end of the connecting portion is greater than an outer diameter of the deformable portion, and the deformable portion is configured to protrude radially outwards under an external force, to cooperate with the distal end of the connecting portion to clamp the member to be riveted; and a limiting portion, wherein the connecting portion is connected to the deformable portion through the limiting portion, an outer diameter of the limiting portion is greater than the outer diameter of the deformable portion and less than the outer diameter of the distal end of the connecting portion, and the limiting portion is configured such that, when the deformable portion is inserted into an opening of the member to be riveted during riveting the pipe joint to the member to be riveted, the limiting portion abuts against the opening to restrain the pipe joint from rotating around an axis extending along the through hole of the pipe joint.

In another aspect of the present application, a riveting assembly is provided, including: a member to be riveted, wherein the member to be riveted has a fluid channel, and at least one opening is formed in a pipe wall of the fluid channel; and the pipe joint as described in the claims and embodiments of the present application, wherein the deformable portion of the pipe joint is inserted into the fluid channel through the opening and radially outwards protrudes under an external force to cooperate with a distal end of the connecting portion to clamp the pipe wall of the fluid channel, thereby fixing the pipe joint to the member to be riveted.

In still another aspect of the present application, a mounting method for mounting the pipe joint as described in the claims or embodiments of the present application to a member to be riveted, including: providing a member to be riveted, wherein the member to be riveted has a fluid channel, and at least one opening is formed in a pipe wall of the fluid channel; inserting the deformable portion of the pipe joint into the fluid channel through the opening, and causing the limiting portion to abut against the opening; and applying a force to the deformable portion, thereby causing the deformable portion to radially outwards protrude to cooperate with a distal end of the connecting portion to clamp the pipe wall of the fluid channel.

In yet another aspect of the present application, a pipe joint adapted to be riveted to a member to be riveted is provided, including: a main body having a through hole extending through the main body, and the main body includes: a connecting portion, wherein the connecting portion includes a proximal end for connecting a pipeline and a distal end relatively away from the proximal end; a deformable portion, a proximal end of which is connected to the distal end of the connecting portion, wherein an outer diameter of the distal end of the connecting portion is greater than an outer diameter of the deformable portion, and the deformable portion is configured to protrude radially outwards under an external force, to cooperate with the distal end of the connecting portion to clamp the member to be riveted, the main body further includes a pulling riveting portion, where a proximal end of the pulling riveting portion is connected to the distal end of the deformable portion; and at the pulling riveting portion, the through hole is at least partially provided with an internal thread for being engaged with a riveting tool, wherein the deformable portion is connected to the pulling riveting portion through a breakable portion, and the breakable portion is easy to beak under an external force, thereby separating the pulling riveting portion from the pipe joint.

In still yet another aspect of the present application, a pipe joint structure is provided, including: a main body portion, where the main body portion has a cavity for communication inside; a deformable portion is arranged at a middle position of the main body portion; two sides of the deformable portion are respectively connected with a pulling riveting portion and a connecting portion; an internal thread is provided on an inner wall of the connecting portion; and an outer diameter of the connecting portion is greater than an outer diameter of the deformable portion.

In some embodiments, a side wall of the connecting portion facing the direction of the deformable portion is provided with a stepped section; and a sealing slot is formed in the side wall of the stepped section facing the deformable portion.

In some embodiments, a sealing strip is mounted inside the sealing slot or the sealing slot is filled with a sealant.

In some embodiments, a connection between the stepped section and the deformable portion has a slope portion, and an inclination angle of the slope portion is 45°.

In some embodiments, an outer wall of the deformable portion is provided with a knurled structure.

In some embodiments, a cross section of the deformable portion is provided with a polygonal structure.

In some embodiments, a plurality of protrusions are arranged on a side wall of the stepped section in a spacing manner.

In another aspect of the present application, a pipe joint mounting structure is provided, including the pipe joint structure described in the above embodiments. The pulling riveting portion on the main body portion is arranged through a rectangular pipe, and the connecting portion on the main body portion abuts against an outer wall of the rectangular pipe. The deformable portion is squeezed to deform into a blocking portion. The blocking portion abuts against an inner wall of the rectangular pipe.

In some embodiments, a side wall of the connecting portion facing the direction of the deformable portion is provided with a stepped section; and a sealing slot is formed in the side wall of the stepped section facing the deformable portion. A sealing strip is mounted inside the sealing slot or the sealing slot is filled with a sealant, to seal a connection between the stepped section and the outer wall of the rectangular pipe.

In some embodiments, a connection between the stepped section and the deformable portion is provided with a slope portion; and the slope portion squeezes a wall surface of a connecting hole of the rectangular pipe to form a blocking structure for sealing a connection between the stepped section and the outer wall of the rectangular pipe.

In some embodiments, characterized in that an outer wall of the deformable portion is provided with a knurled structure for forming a blocking portion with a tooth-shaped cross section.

In some embodiments, characterized in that a cross section of the deformable portion is provided with a polygonal structure for forming a blocking portion with a polygonal cross section.

In some embodiments, a plurality of protrusions are arranged on a side wall of the stepped section in a spacing manner, and the plurality of protrusions are squeezed and embedded into the outer wall of the rectangular pipe.

In some embodiments, the deformable portion is annealed.

In still another aspect of the present application, a liquid cooling pipe joint with low head loss is provided, including a flange portion, and a body and a deformable portion that are coaxially arranged on two sides of the flange portion. The deformable portion further has a pulling riveting portion at one end facing away from the flange portion. The deformable portion is in breakable connection to the pulling riveting portion through a connecting portion. A through hole extending through the pulling riveting portion is formed in an end surface of the body facing away from the flange portion. The pulling riveting portion has a pulling riveting thread that can be connected to a pulling riveting tool.

In some embodiments, a sealing slot surrounding the deformable portion is formed in one side of the flange portion facing away from the body, and the sealing slot is configured to receive a sealing ring.

In some embodiments, a limiting portion is arranged at a connection between the flange portion and the deformable portion.

In some embodiments, the limiting portion is provided with a polygonal structure that is coaxial with the flange portion.

In some embodiments, an inner wall of the body has an internal thread, and a diameter of the internal thread is greater than a diameter of the pulling riveting thread.

In some embodiments, an outer diameter of the pulling riveting portion is less than or equal to an outer diameter of the deformable portion.

In some embodiments, a wall thickness of the connecting portion is less than a wall thickness of the deformable portion.

In yet another aspect of the present application, a connecting structure for a liquid cooling pipe joint with low head loss is provided, including: a tubular profile, where a mounting hole is formed in the tubular profile; and the liquid cooling pipe joint, where the liquid cooling pipe joint includes a flange portion, and a body and a deformable portion that are coaxially arranged on two sides of the flange portion, and the deformable portion can at least partially deform into a deformation unit. The deformable portion further has a pulling riveting portion at one end facing away from the flange portion. The deformable portion is in breakable connection to the pulling riveting portion through a connecting portion. A through hole extending through the pulling riveting portion is formed in the body. The pulling riveting portion has a pulling riveting thread that can be connected to a pulling riveting tool. The liquid cooling pipe joint passes through the mounting hole of the tubular profile. The pulling riveting portion is broken from the deformable portion under the action of a pulling riveting tool, and the deformable portion at least partially deforms into the deformation unit under the action of the pulling riveting portion. The deformation unit and the flange portion clamp a plate of the tubular profile having the mounting hole, thereby riveting the liquid cooling pipe joint to the tubular profile. The pulling riveting portion is broken and separated from the changed deformation unit to reduce head loss.

In some embodiments, a limiting portion is arranged at a connection between the flange portion and the deformable portion. A limiting hole matching the limiting portion is formed in an end surface of the tubular profile.

In some embodiments, a sealing slot surrounding the deformable portion is formed in one side of the flange portion facing away from the body, and the sealing slot is configured to accommodate a sealing ring. The flange portion and an end surface of the tubular profile compress the sealing ring.

In another aspect of the present application, a use method of a liquid cooling pipe joint with low head loss is provided, including the following steps: step I, providing the liquid cooling pipe joint, where the liquid cooling pipe joint includes a flange portion, and a body and a deformable portion that are coaxially arranged on two sides of the flange portion; the deformable portion further has a pulling riveting portion at one end facing away from the flange portion; the deformable portion is in breakable connection to the pulling riveting portion through a connecting portion; a through hole extending through the pulling riveting portion is formed in an end surface of the body facing away from the flange portion; an inner wall of the pulling riveting portion has a pulling riveting thread that can be connected to a pulling riveting tool; step II, providing a tubular profile, where the tubular profile has a mounting hole for riveting the liquid cooling pipe joint; step III, inserting one end of the liquid cooling pipe joint with the pulling riveting portion into the mounting hole, and clinging the flange portion against an end surface of the tubular profile that is formed with the mounting hole; step IV, connecting the pulling riveting tool to the pulling riveting portion, pulling the pulling riveting portion to be separated from the deformable portion, continuing to pull the pulling riveting portion by the pulling riveting tool to cause the pulling riveting portion to continue to move towards the flange portion, where the pulling riveting portion abuts against the deformable portion, thereby causing the deformable portion to undergo plastic deformation and form a deformation unit riveted to the tubular profile; and step V, rotating back the pulling riveting tool for being separated from the pulling riveting portion, thereby disconnecting the pulling riveting portion.

In some embodiments, step III further includes: forming a sealing slot surrounding the deformable portion in one side of the flange portion facing away from the body, where the sealing slot is configured to receive a sealing ring, and the flange portion and the end surface of the tubular profile that is formed with the mounting hole compress the sealing ring.

In some embodiments, step III further includes: arranging a limiting portion at a connection between the flange portion and the deformable portion, where a limiting hole matching the limiting portion is formed in an end surface of the tubular profile.

In still another aspect of the present application, a use method of a liquid cooling pipe joint with low head loss is provided, including the following steps: step I, providing the liquid cooling pipe joint, where the liquid cooling pipe joint includes a flange portion, and a body and a deformable portion that are coaxially arranged on two sides of the flange portion; the deformable portion further has a pulling riveting portion at one end facing away from the flange portion; the deformable portion is in breakable connection to the pulling riveting portion through a connecting portion; a through hole extending through the pulling riveting portion is formed in an end surface of the body facing away from the flange portion; an inner wall of the pulling riveting portion has a pulling riveting thread that can be connected to a pulling riveting tool; step II, providing a tubular profile, where the tubular profile has a mounting hole for riveting the liquid cooling pipe joint; step III, inserting one end of the liquid cooling pipe joint with the pulling riveting portion into the mounting hole, and clinging the flange portion against an end surface of the tubular profile that is formed with the mounting hole; step IV, connecting the pulling riveting tool to the pulling riveting portion, and pulling the pulling riveting portion to move towards the flange portion, thereby causing the deformable portion to undergo plastic deformation and at least partially become a deformation unit riveted to the tubular profile; and step V, continuing to pull the pulling riveting portion by the pulling riveting tool until the pulling riveting portion is broken and separated from the deformation unit, and rotating back the pulling riveting tool for being separated from the pulling riveting portion, thereby disconnecting the pulling riveting portion.

### BRIEF DESCRIPTION OF DRAWINGS

The above and other features of the content of the present application will be understood more fully and clearly through this specification and attached claims and in conjunction with the accompanying drawings. It can be understood that these accompanying drawings only depict several implementations of the present application and should not be considered as limiting the scope of the present application. By referring to the drawings, the contents of the present application will be described more clearly and in greater detail.

FIG. 1A schematically shows a perspective view of a pipe joint according to one embodiment of the present application;

FIG. 1B schematically shows a cross-sectional view of the pipe joint shown in FIG. 1A;

FIG. 1C schematically shows a cross-sectional view of a riveting assembly formed after the pipe joint shown in FIG. 1A is riveted to a member to be riveted;

FIG. 1D schematically shows a perspective view of a pipe joint according to another embodiment of the present application;

FIG. 2A schematically shows a perspective view of a pipe joint according to another embodiment of the present application;

FIG. 2B schematically shows a cross-sectional view of the pipe joint shown in FIG. 2A;

FIG. 2C schematically shows a cross-sectional view of a riveting assembly formed after the pipe joint shown in FIG. 2A is riveted to a member to be riveted;

FIG. 3A schematically shows a perspective view of a pipe joint according to another embodiment of the present application;

FIG. 3B schematically shows a cross-sectional view of the pipe joint shown in FIG. 3A;

FIG. 3C schematically shows a cross-sectional view of a riveting assembly formed after the pipe joint shown in FIG. 3A is riveted to a member to be riveted;

FIG. 4A schematically shows a perspective view of a pipe joint according to another embodiment of the present application;

FIG. 4B schematically shows a cross-sectional view of the pipe joint shown in FIG. 4A;

FIG. 5A schematically shows a perspective view of a pipe joint according to another embodiment of the present application;

FIG. 5B schematically shows a cross-sectional view of the pipe joint shown in FIG. 5A;

FIG. 5C schematically shows a cross-sectional view of a riveting assembly formed after the pipe joint shown in FIG. 5A is riveted to a member to be riveted;

FIG. 5D schematically shows a perspective view of a pipe joint according to still another embodiment of the present application;

FIG. 6 shows a flowchart of a mounting method for mounting a pipe joint to a member to be riveted according to one embodiment of the present application;

FIG. 7A schematically shows a perspective view of one step of forming a flat mounting region on a member to be riveted according to one embodiment of the present application;

FIG. 7B schematically shows a cross-sectional view of the step shown in FIG. 7A;

FIG. 7C schematically shows a perspective view of one step of forming a flat mounting region on a member to be riveted according to one embodiment of the present application;

FIG. 7D schematically shows a cross-sectional view of the step shown in FIG. 7C;

FIG. 7E schematically shows a perspective view of the member to be riveted having a flat mounting region that is formed according to the steps shown in FIG. 7A and FIG. 7C; and

FIG. 7F schematically shows a perspective view of the member to be riveted shown in FIG. 7E after being riveted with a pipe joint according to one embodiment of the present application.

### DETAILED DESCRIPTION

The following detailed description has been referred to in the accompanying drawings that form a portion of the description. In the accompanying drawings, similar symbols usually represent similar constitutes, unless otherwise specified in the context. The illustrative implementations described in the detailed description, accompanying drawings, and claims are not intended to be limitative. Without departing from the spirit or scope of the subject matter of the present application, other implementations may be employed and other changes may be made. It can be understood that various configurations, substitutions, combinations, and designs can be made to the various aspects of the content of the present application generally described in the present application and illustrated in the accompanying drawings, and all these clearly constitute a portion of the content of the present application.

In the present application, unless otherwise specified, a singular form also includes a plural form. In the present application, unless otherwise specified, “or” means “and/or”. In addition, the term such as “include”, “contain”, and “have” should be understood as open terms and may not be constructed as exclusiveness or limitation. In addition, unless otherwise specified, the terms such as “element” or “assembly” cover elements and assemblies that include one unit, as well as elements and assemblies that include more than one subunit. In addition, the chapter titles used herein are for an organization purpose only and should not be interpreted as limiting the subjects described.

As used herein, the spatially relative terms such as “below”, “underneath”, “upper”, “above”, “on”, “upper side”, “lower side”, “left side”, “right side”, “horizontal”, “vertical”, and the like can be used herein to describe the relationship between one element or feature shown in the accompanying drawings and another element or feature. In addition to the directions depicted in the drawings, the spatially relative terms are intended to encompass different directions in which the device is used or operated. The device can be oriented in other ways (rotated 90 degrees or in other directions), and the space-correlated descriptors used herein can also be explained correspondingly. It should be understood that when an element is referred to as being “connected” or “coupled” to another element, it can be directly connected or coupled to another element, or there may be an intermediate element.

It should be noted that a riveted pipe joint described in the present application can be any joint component for being riveted to a member to be riveted. Fluid communication between a fluid channel in the member to be riveted and a pipeline connected to the pipe joint is established through a through hole of the pipe joint. The pipe joint can employ any structure or layout that can achieve the above function, such as a straight pipe joint, a bent pipe joint, or a multi-path pipe joint. Meanwhile, an external contour of the pipe joint or a cross section of an internal through hole can be designed as any shape such as a circular shape, a rectangular shape, or another polygonal shape as needed. The member to be riveted in the present application can be any component with a fluid channel. The fluid channel can be a part of a liquid cooling system, such as a coolant fluid channel arranged inside a server or an electrical equipment stand. Certainly, the member to be riveted can also be an entirety or a part of any equipment, device, or component with a fluid channel for other purposes.

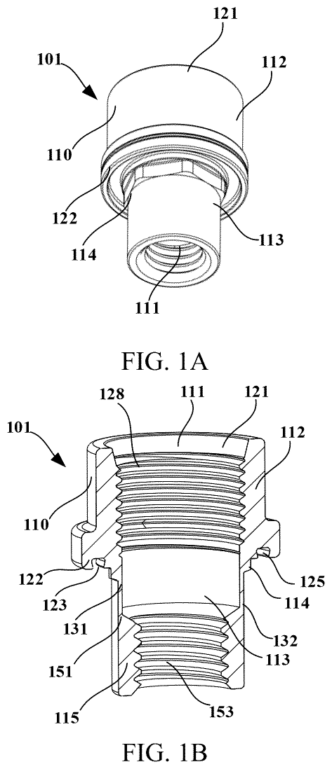

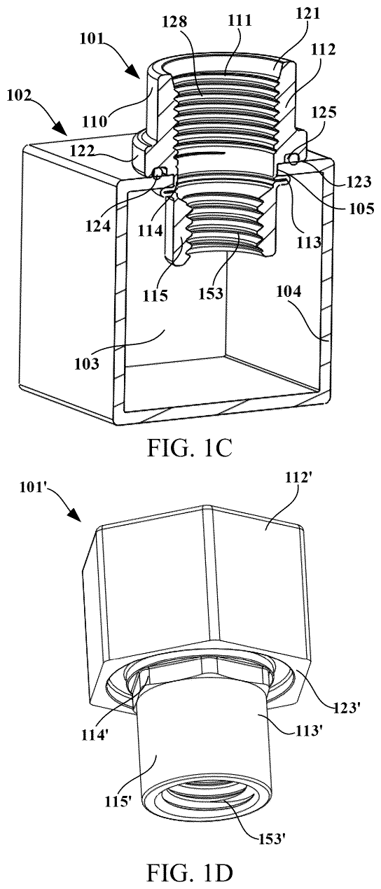

FIG. 1A schematically shows a perspective view of a pipe joint 101 according to one embodiment of the present application. FIG. 1B schematically shows a cross-sectional view of the pipe joint 101 shown in FIG. 1A. FIG. 1C schematically shows a cross-sectional view of a riveting assembly formed after the pipe joint 101 shown in FIG. 1A is riveted to a member to be riveted 102.

As shown in FIG. 1A to FIG. 1C, the pipe joint 101 adapted to be riveted includes a main body 110 and a through hole 111 extending through the main body 110. The main body 110 includes a connecting portion 112 and a deformable portion 113. The connecting portion 112 includes a proximal end 121 for connecting a to-be-connected pipeline or pipe fitting and a distal end 122 relatively far away from the proximal end 121. A proximal end 131 of the deformable portion 113 is connected to the distal end 122 of the connecting portion 112, and an outer diameter of the distal end 122 is greater than an outer diameter of the deformable portion 113. Although in the embodiments shown in the figures, the distal end 122 of the connecting portion 112 is of a flange structure, and the outer diameter of the distal end 122 is greater than an outer diameter of the proximal end 121, in some embodiments, the entire connecting portion 112 may alternatively be of a structure with a uniform outer diameter, and the overall outer diameter of the connecting portion 112 is greater than an outer diameter of the deformable portion 113. It should be noted that the “outer diameter” referred to in the present application is not limited to a diameter of a circular cross section. For a non-circular structure, the “outer diameter” should be understood as a corresponding external dimension, such as a maximum external dimension or an equivalent dimension. In addition, although a peripheral contour of the connecting portion 122 of the pipe joint shown in FIG. 1A to FIG. 1C has a circular cross section, it is evident that the peripheral contour of the connecting portion 122 may alternatively have any other cross-sectional shape. FIG. 1D schematically shows a perspective view of a pipe joint 101′ according to another embodiment of the present application. A main difference between the pipe joint shown in FIG. 1A and the pipe joint 101′ shown in FIG. 1D is the connecting portion 112′. Specifically, a peripheral contour of the connecting portion 112′ of the pipe joint 101′ shown in FIG. 1D has a hexagonal cross section. This shape facilitates a riveting operation on the pipe joint 101′. In some embodiments, the connecting portion 112′ of the pipe joint 101′ may alternatively have another peripheral contour. For example, the connecting portion 112′ may be an elongated structure having a peripheral contour with an elliptical cross section, a square cross section, a star-shaped cross section, or any other polygonal cross section. As shown in FIG. 1B, the through hole 111 is provided with an internal thread 128 at a position corresponding to the connecting portion 112, whereby the to-be-connected pipeline or pipe fitting can implement fluid connection with the pipe joint 101 by cooperation with the internal thread 128. In some embodiments, the connecting portion 112 may alternatively have another structure for connecting a pipeline or a pipe fitting, for example, an external thread structure at least partially arranged on an outer surface of the connecting portion 112, a groove structure at least partially arranged on an outer surface of the connecting portion 112, a tapered transition surface structure, or an inverted tooth structure. As shown in FIG. 1C, when the pipe joint 101 is riveted to the member to be riveted 102, the deformable portion 113 protrudes radially outwards under an external force. After deformation, the radially outwards protruding deformable portion 113 cooperates with the distal end 122 of the connecting portion 112 to clamp a pipe wall 104 of the member to be riveted 102, thereby fixing the pipe joint 101 to the member to be riveted 102.

Continuing to refer to FIG. 1B, the proximal end 131 of the deformable portion 113 is connected to the distal end 122 of the connecting portion 112 through a limiting portion 114. Meanwhile, an outer diameter of the limiting portion 114 is greater than the outer diameter of the deformable portion 113 and less than the outer diameter of the distal end 122 of the connecting portion 112, and a cross section of a peripheral contour of the limiting portion 114 is polygonal. In this case, when the deformable portion 113 is inserted into an opening 105 on the member to be riveted 102 shown in FIG. 1C to rivet the pipe joint 101 to the member to be riveted 102, the limiting portion 114 abuts against an opening 105 with a corresponding size and shape, to restrain the pipe joint 101 from rotating around an axial direction of the through hole 111 of the pipe joint 101. Specifically, the opening 105 may alternatively be in a polygonal shape or another corresponding shape, to restrain the limiting portion 114 from rotating inside the opening 105. Therefore, by the structural setting of the limiting portion 114, the pipe joint 101 can be effectively prevented from rotating around an axis of the through hole 111 of the pipe joint 101 or sliding in the process of riveting the pipe joint 101 to the member to be riveted 102, thereby improving stability and reliability of a finally formed riveted structure and avoiding looseness or a failure caused by torsion. In addition, after the pipe joint 101 is riveted to the member to be riveted 102, the abutment between the limiting portion 114 and the opening 105 can effectively improve torsional resistance of the pipe joint, thereby improving durability of a connected structure.

It should be noted that although in the embodiments shown in the figures, the limiting portion 114 achieves the torsional resistance effect by abutting against the corresponding opening 105 through its peripheral contour with the polygonal cross section, in some embodiments, the limiting portion 114 may alternatively be of another structure or configuration that can achieve the torsional resistance effect by abutting against the opening 105. For example, in some embodiments, the peripheral contour of the limiting portion 114 may be a non-circular contour, for example a peripheral contour with a D-shaped, hexagonal, or elliptical cross section, so that the limiting portion 114 may abut against an opening 105 having a corresponding contour, thereby providing the torsional resistance effect. In some other embodiments, at least one protrusion, such as a pair of convex lug structures, may be arranged on a peripheral surface of the limiting portion 114. During use, the protrusion may match a corresponding recess structure on the opening 105, thereby achieving the torsional resistance effect. In still some other embodiments, a surface structure, such as a knurled structure, a granular protruding structure, and a rubber coating structure, for enhancing a frictional force is arranged on a peripheral surface of the limiting portion. The surface structure for enhancing the frictional force is engaged with an inner wall of the opening 105 to enhance the frictional force between the peripheral surface of the limiting portion 114 and the inner wall of the opening 105, thereby achieving the torsional resistance effect.

As shown in FIG. 1A to FIG. 1C, a groove 125 is further formed in an outer end surface 123 (which is an end surface facing the deformable portion 113) of the distal end 122 of the connecting portion 112. The groove is arranged around a periphery of the deformable portion 113 and is configured to accommodate a sealing element 124. After the pipe joint 101 is riveted to the member to be riveted 102, the sealing element 124 arranged inside the groove 125 can effectively implement fluid sealing between the pipe joint 101 and the member to be riveted 102. Although the sealing element 124 shown in the figures is of an O-ring structure, in some other embodiments, the sealing element 124 may alternatively be of another structure that can achieve a sealing effect, such as a gasket structure. In some other embodiments, a silicone or rubber coating layer may be arranged on the outer end surface 123 of the connecting portion 112, to achieve the sealing effect. In some embodiments, in the process of riveting the pipe joint 101 to the member to be riveted 102, the outer end surface 123 is at least partially coated with a liquid sealant (such as silicone or an anaerobic adhesive) to implement fluid sealing between the pipe joint 101 and the member to be riveted 102.

Continuing to refer to FIG. 1B and FIG. 1C, the main body 110 further includes a pulling riveting portion 115. A proximal end 151 of the pulling riveting portion 115 is connected to the distal end 132 of the deformable portion 113. The through hole 111 is at least partially provided with an internal thread 153 at the pulling riveting portion 115. The internal thread 153 may be configured to be engaged with a riveting tool, so as to drive the pulling riveting portion 115 to move towards the deformable portion 113 when the riveting tool is rotated, thereby driving the deformable portion 113 to undergo the radially outwards protruding deformation shown in FIG. 1C, to cooperate with the distal end 122 of the connecting portion 112 to clamp the pipe wall 104 of the member to be riveted 102. As shown in the figures, a diameter of the through hole 111 at the pulling riveting portion is less than diameters of the through hole 111 at both the connecting portion 112 and the deformable portion 113.

FIG. 1C schematically shows a cross-sectional view of a riveting assembly formed after the pipe joint shown in FIG. 1A is riveted to a member to be riveted. As shown in the figure, the riveting assembly includes the member to be riveted 102. The member to be riveted 102 includes a fluid channel 103, and an opening 105 is formed in a pipe wall 104 of the fluid channel 103. The deformable portion 113 of the pipe joint 101 is inserted into the fluid channel 103 through the opening 105, and the deformable portion 113 which radially outwards protrudes after deformation cooperates with the distal end 122 of the connecting portion 112 to clamp the pipe wall 104 of the fluid channel 103, thereby fixing the pipe joint 101 to the member to be riveted 102. As shown in FIG. 1C, the limiting portion 114 of the pipe joint 103 abuts against the opening 105, thereby restraining the pipe joint 103 from rotating around an axis of an extension direction of the through hole 111.

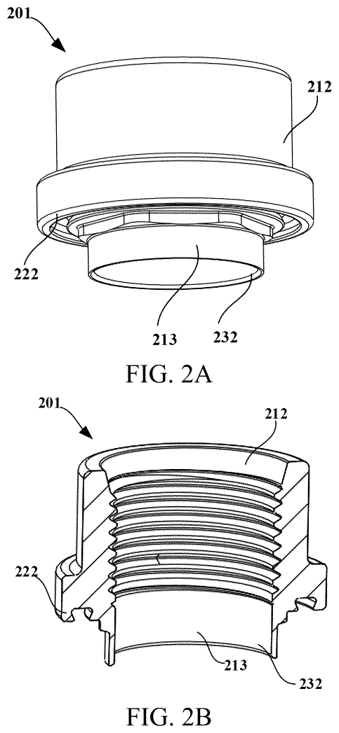

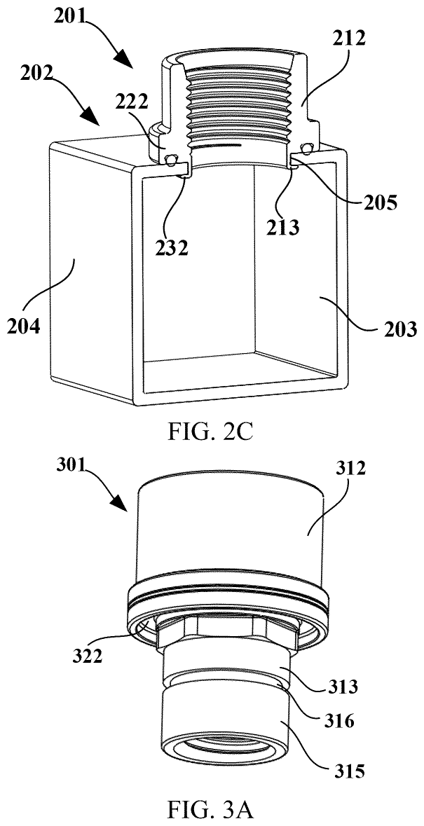

FIG. 2A schematically shows a perspective view of a pipe joint 201 according to another embodiment of the present application. FIG. 2B schematically shows a cross-sectional view of the pipe joint 201 shown in FIG. 2A. FIG. 2C schematically shows a cross-sectional view of a riveting assembly formed after the pipe joint 201 shown in FIG. 2A is riveted to a member to be riveted 202.

FIG. 2A to FIG. 2C show the pipe joint 201 that is similar to the pipe joint 101 shown in FIG. 1A. The entire structure of the pipe joint 201 and the entire structure of the pipe joint 101 are substantially the same, and a main difference therebetween lies in the deformable portion and the pulling riveting portion. Specifically, a main body 210 of the pipe joint 201 does not include a pulling riveting portion for being engaged with a riveting tool. Correspondingly, a deformable portion 213 of the pipe joint 201 is configured to cause a distal end 232 of the deformable portion 213 to be radially outwards folded under an external force to cooperate with a distal end 222 of a connecting portion 212 to clamp the member to be riveted 202.

FIG. 2C shows a cross-sectional view of a riveting assembly formed after the pipe joint 201 shown in FIG. 2A is riveted to a member to be riveted 202. As shown in the figure, the riveting assembly includes the member to be riveted 202 having a fluid channel 203. Furthermore, an opening 205 is formed in a pipe wall 204 of the fluid channel 203. A deformable portion 213 of the pipe joint 201 is inserted into the fluid channel 203 through the opening 205, and a distal end 232 of the deformable portion 232 is radially outwards folded under an external force and cooperates with a distal end 222 of a connecting portion 212 to clamp a pipe wall 204 of the fluid channel 203, thereby fixing the pipe joint 201 to the member to be riveted 202. Other structures of the riveting assembly are substantially the same as those of the riveting assembly shown in FIG. 1C, and will not be elaborated here. By using the special configuration of the deformable portion 213, the finally mounted deformable portion 213 can fit as closely as possible to the pipe wall 204, thereby reducing the impact of the excessively protruding deformable portion and pulling riveting portion on flowing of a fluid inside the fluid channel 203.

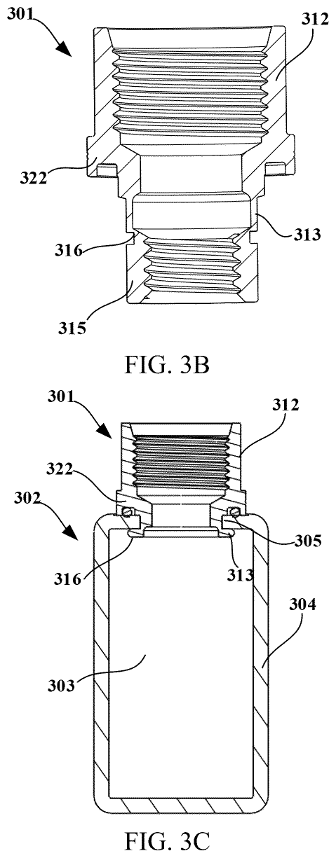

FIG. 3A schematically shows a perspective view of a pipe joint 301 according to another embodiment of the present application. FIG. 3B schematically shows a cross-sectional view of the pipe joint 301 shown in FIG. 3A. FIG. 3C schematically shows a cross-sectional view of a riveting assembly formed after the pipe joint 301 shown in FIG. 3A is riveted to a member to be riveted.

FIG. 3A to FIG. 3C show the pipe joint 301 that is similar to the pipe joint 101 shown in FIG. 1A. The entire structure of the pipe joint 301 and the entire structure of the pipe joint 101 are substantially the same, and a main difference therebetween is that a breakable portion 316 is further arranged between the deformable portion 313 and the pulling riveting portion 315 of the pipe joint 301. The breakable portion 316 is configured to be broken under an external force, so that after a riveting operation is completed, the pulling riveting portion 315 can be separated from the pipe joint 301.

FIG. 3C shows a cross-sectional view of a riveting assembly formed after the pipe joint 301 shown in FIG. 3A is riveted to a member to be riveted 302. As shown in the figure, the riveting assembly includes the member to be riveted 302 having a fluid channel 303. Furthermore, an opening 305 is formed in a pipe wall 304 of the fluid channel 303. A deformable portion 313 of the pipe joint 301 is inserted into the fluid channel 303 through the opening 305 and radially outwards deforms under an external force, to cooperate with a distal end 322 of a connecting portion 312 to clamp a pipe wall 304 of the fluid channel 303, thereby fixing the pipe joint 301 to the member to be riveted 302. Compared with the structure of the riveting assembly shown in FIG. 1C, a main difference is that no pulling riveting portion 315 is provided, thereby effectively reducing the impact of the pulling riveting portion on flowing of a fluid inside the fluid channel 303.

Continuing to refer to FIG. 3A and FIG. 3B, an outer diameter of the breakable portion 316 is less than an outer diameter of the deformable portion 313 and an outer diameter of the pulling riveting portion 315, thereby forming a reduced-diameter section. Therefore, under an external force, the breakage portion 316 is easy to break. In some embodiments, the breakable portion 316 may alternatively be a V-shaped groove or an incision at least partially arranged circumferentially between the deformable portion 313 and the pulling riveting portion 315, thereby forming a stress concentration region that is prone to controllable breakage under the external force. In some other embodiments, the breakable portion 316 may have a smaller wall thickness, for example, a wall thickness less than a wall thickness of the deformable portion 313 and a wall thickness of the pulling riveting portion 315, thereby achieving the breakable effect. In some other embodiments, the breakable portion 316 may alternatively be a perforated structure partially arranged circumferentially between the deformable portion 313 and the pulling riveting portion 315. Due to presence of one or more holes arranged in the circumferential direction, this region can lower mechanical strength of a part between the deformable portion 313 and the pulling riveting portion 315, making the part easy to break. It should be noted that those skilled in the art can understand that the breakable portion 316 may alternatively employ any other structures or configurations that easily form controlled breakage in this region, such as a recess, serration, or an opening structure arranged in this region. A person skilled in the art can also understand that the configurations on the breakable portion 316 may be a ringlike structure along its peripheral surface, or a discontinuous structure locally formed on its peripheral surface. In addition, a person skilled in the art can also understand that in addition to the effect of the structural setting, the breakable portion 316 may alternatively employ a material different from materials of other parts of the pipe joint 301, thereby achieving the above effect through breakability of the material itself.

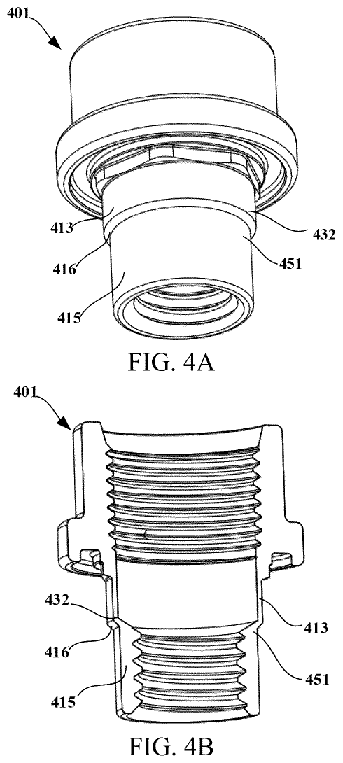

FIG. 4A schematically shows a perspective view of a pipe joint 401 according to another embodiment of the present application. FIG. 4B schematically shows a cross-sectional view of the pipe joint 401 shown in FIG. 4A.

The pipe joint 401 in FIG. 4A and FIG. 4B includes a configuration of another type of breakable portion 416. Specifically, the breakable portion 416 is a tapered transition section structure arranged between a deformable portion 413 and a pulling riveting portion 415. An external contour of the breakable portion 416 gradually narrows from a distal end 432 of the deformable portion 413 to a proximal end 451 of the pulling riveting portion 415, thereby implementing a controllable breakage direction and strength, and a finally formed broken structure is relatively natural. Except for the breakable portion 416, other structures of the pipe joint 401 are basically the same as those of the pipe joint 301 shown in FIG. 3A and FIG. 3B, and will not be elaborated here.

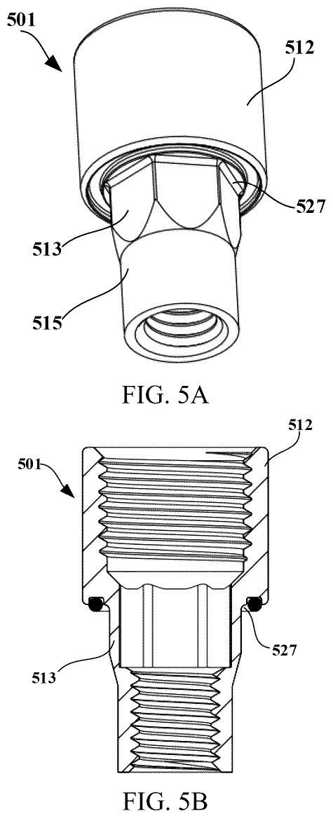

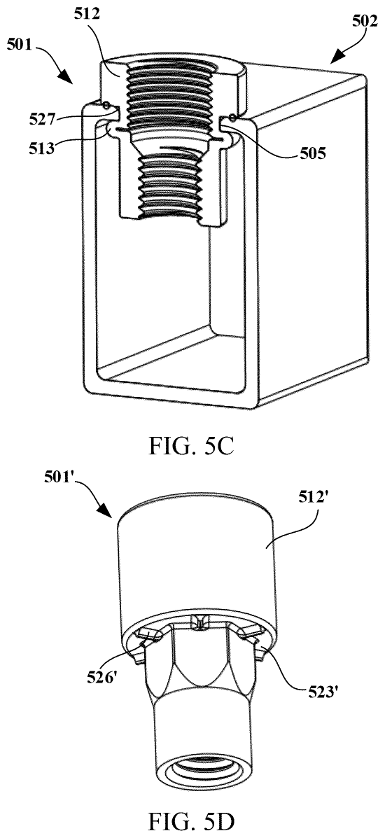

FIG. 5A schematically shows a perspective view of a pipe joint 501 according to another embodiment of the present application. FIG. 5B schematically shows a cross-sectional view of the pipe joint 501 shown in FIG. 5A. FIG. 5C schematically shows a cross-sectional view of a riveting assembly formed after the pipe joint 501 shown in FIG. 5A is riveted to a member to be riveted 502.

A main difference between the pipe joint 501 shown in FIG. 5A to FIG. 5C and the pipe joint 101 shown in FIG. 1A to FIG. 1C is that an external contour of a deformable portion 513 of the pipe joint 501 is a polygonal contour, so that the deformable portion 513 can directly abut against a matching opening, to restrain the pipe joint 501 from rotating around an axis of a through hole of the pipe joint 501. In addition to the above difference, a transition slope 527 is further arranged between a connecting portion 512 and the deformable portion 513 of the pipe joint 501. The transition slope 527 forms an angle of 30 to 60 degrees, preferably 45 degrees, with an axis of the pipe joint 501 in an extension direction of the through hole. By the arrangement of the transition slope 527, as shown in FIG. 5C, in the process of riveting the pipe joint 501 to the member to be riveted 502, the transition slope 527 can squeeze an edge of the opening 505, thereby forming a more effective sealing structure between the transition slope 527 and the edge of the opening 505.

FIG. 5D schematically shows a perspective view of a pipe joint 501′ according to still another embodiment of the present application. As shown in the figure, a main difference between the pipe joint 501′ and the pipe joint 501 shown in FIG. 5A is that a protrusion 526′ is formed on an outer end surface 523′ of a distal end of the connecting portion 512′. The protrusion 526′ can enhance friction between the outer end surface 523′ and an outer wall surface close to an opening of a member to be riveted, thereby also restraining the pipe joint 501′ from rotating around the axis of the through hole of the pipe joint 501′. It should be noted that although the protrusion 526′ shown in the figure is a plurality of protrusions 526′ extending radially outwards, the protrusion 526′ may alternatively be arranged in other ways, such as point-like structures arranged on the outer end surface 523′. In addition, a person skilled in the art can also understand that another surface structure for enhancing a frictional force may be arranged on the outer end surface 523′ to achieve the above torsional resistance effect, such as a knurled structure, a tooth structure, and a rubber coating structure.

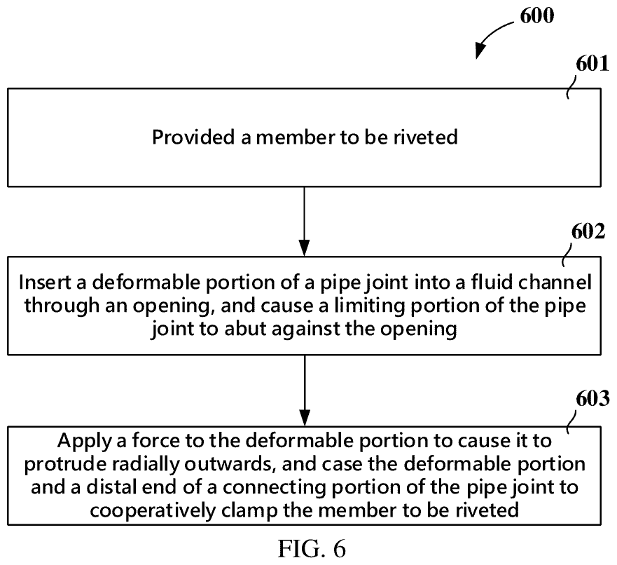

FIG. 6 shows a flowchart of a method 600 for mounting a pipe joint to a member to be riveted according to one embodiment of the present application. The method 600 will be described below with reference to FIG. 1A to FIG. 1C. First, in step 601, the member to be riveted 102 shown in FIG. 1C is provided. As mentioned above, the member to be riveted 102 can be any component with a fluid channel. The fluid channel of the member to be riveted 102 can be a part of a liquid cooling system, such as a coolant fluid channel arranged inside a server or an electrical equipment stand. Certainly, the member to be riveted can also be an entirety or a part of any equipment, device, or component with a fluid channel for other purposes. In addition, although the member to be riveted 102 shown in the figure has the fluid channel with a square cross section, the member to be riveted 102 may alternatively have a fluid channel with other cross-sectional shapes, such as a circular cross section or an elliptical cross section.

In step 602, the deformable portion 113 of the pipe joint 101 is inserted into the fluid channel 103 through the opening 105, and the limiting portion 114 of the pipe joint 101 abuts against the opening 105, to restrain the pipe joint 101 from rotating around the axis of the through hole 111 of the pipe joint 101.

Subsequently, in step 603, a force is applied to the deformable portion 113 to cause the deformable portion 113 to undergo radially outward protruding deformation as shown in FIG. 1C to clamp the pipe wall 104 of the member to be riveted 102 together with the distal end 122 of the connecting portion 112 of the pipe joint 101. In the embodiment shown in FIG. 1C, a riveting tool can be used to apply the force to the deformable portion 113. In some embodiments, the riveting tool used is a pulling riveting tool. A pull rod of the pulling riveting tool can pass through the through hole 111 of the pipe joint 103, and a thread at a tail end of the pull rod can be engaged with the internal thread 153 at the pulling riveting portion 115. Subsequently, the pull rod is rotated to drive the pulling riveting portion 115 to move towards the deformable portion 113, thereby driving the deformable portion 113 to deform. Finally, the deformable portion 113 that protrudes radially outwards cooperates with the distal end 122 of the connecting portion 112 to clamp the pipe wall 104 of the fluid channel 103.

In the process of riveting the pipe joint 201 to the member to be riveted 202 shown in FIG. 2A and FIG. 2B, in step 603, a force is applied to the deformable portion 213 to radially outwards fold the distal end 232 of the deformable portion 213. Finally, the distal end 232 of the deformable portion 213 and the distal end 222 of the connecting portion cooperate to clamp the pipe wall 204 of the fluid channel 203. A person skilled in the art can understand that a riveting tool can be used to apply the force to the deformable portion 213. The riveting tool used can be any tool that can radially outwards fold the distal end of the deformable portion 213, such as a riveting tool with an expandable head end. Specifically, after the expandable head end of the riveting tool is inserted into a position adjacent to the distal end 232 of the deformable portion 213 through the through hole, the expandable head end can be expanded to radially outwards fold the distal end 232 of the deformable portion 213. In some other embodiments, similarly, the riveting tool with the expandable head end can also be used to implement deformations of other deformable portions. Specifically, the expandable head end of the riveting tool is inserted into and passes through the through hole of the pipe joint, and then the expandable head end is opened. Next, the expandable head end is moved towards the deformable portion, so that the deformable portion is driven to move towards the connecting portion. The deformable portion that radially outwards protrudes in this situation may be in the folded form that a middle part of the deformable portion shown in FIG. 1C outwards protrudes, rather than the form that the distal end 232 shown in FIG. 2C is radially outwards folded.

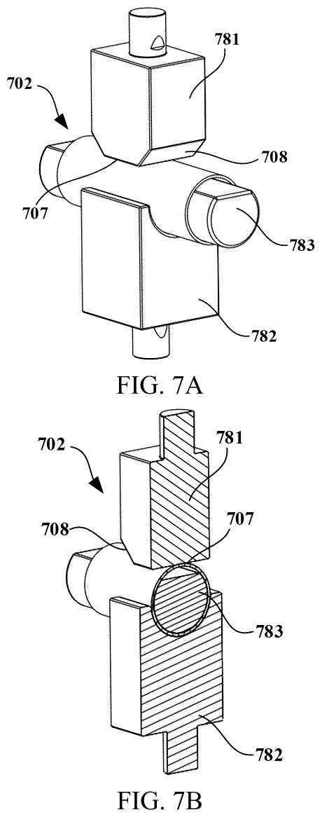

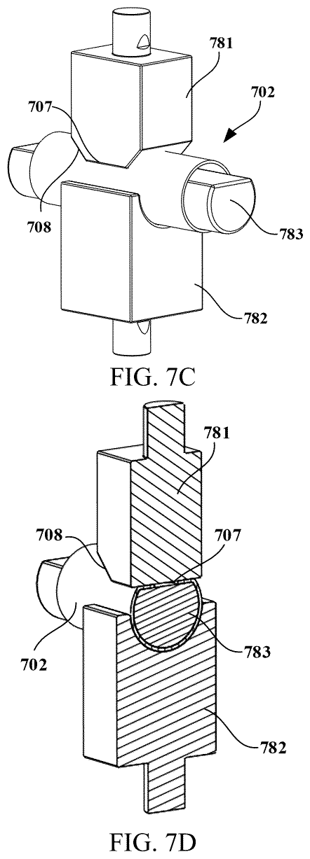

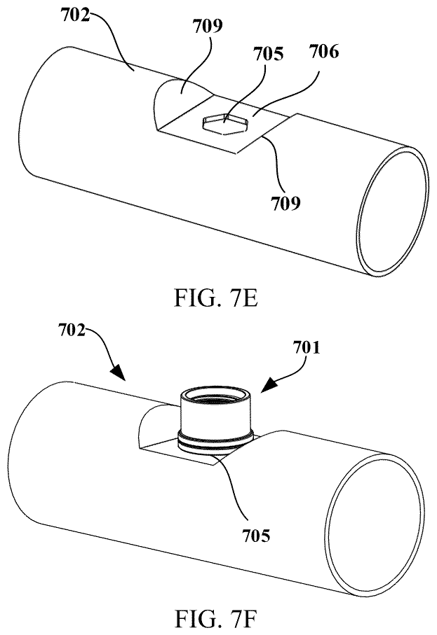

FIG. 7A schematically shows a perspective view of one step of forming a flat region on a member to be riveted 702 according to one embodiment of the present application. FIG. 7B schematically shows a cross-sectional view of the step shown in FIG. 7A. FIG. 7C schematically shows a perspective view of one step of forming a flat region on a member to be riveted 702 according to one embodiment of the present application. FIG. 7D schematically shows a cross-sectional view of the step shown in FIG. 7C.

In the steps shown in FIG. 7A and FIG. 7B, a pressing head 781 is moved to a pipe wall of a region close to an opening of the member to be riveted 702. As shown in the figure, the pressing head 781 has a flat portion 707 and slope portions 708 located on two sides of the flat portion 707. In the steps shown in FIG. 7C and FIG. 7D, the flat portion 707 of the pressing head 781 applies a force to the pipe wall of the region close to the opening of the member to be riveted 702 to form a relatively flat mounting region. Meanwhile, the slope portions 708 of the pressing head 781 apply a pressure to a pipe wall that is close to the relatively flat mounting region in a fluid flowing direction of a fluid channel, to form a flow guiding region close to the relatively flat mounting region. The structure of the member to be riveted 702 finally formed based on the above steps is shown in FIG. 7E, which has a relatively flat mounting region 706 close to an opening 705 and flow guiding regions 709 located on two sides of the mounting region 706 in a fluid flowing direction. The arrangement of the flow guiding regions 709 helps to eliminate the impact of the formation of the flat mounting region 706 on flowing of a fluid in the fluid channel.

As shown in FIG. 7A to FIG. 7D, when a pressure is applied to a pipe wall of the member to be riveted 702 through the pressing head 781, a lower die 783 arranged inside the fluid channel of the member to be riveted 702 can also be used cooperatively. The lower die 783 has a flat portion on at least one side, so as to cooperate with the flat portion of the pressing head 781 to better form the flat mounting region 706 close to the opening. In addition, as shown in the figure, in the implementation of the above steps, the member to be riveted 702 can be arranged on a support component 782. The support component 782 can have an upper surface contour that matches a part of an external contour of the member to be riveted 702 to better support the member to be riveted 702.

The steps shown in FIG. 7A and FIG. 7C can be used as operation steps before the method 600 shown in FIG. 6 is performed, thereby riveting the pipe joint structure described in the embodiments of the present application to a pipe wall with an opening located on a curved contour. FIG. 7F schematically shows a perspective view of the member to be riveted 702 shown in FIG. 7E after being riveted with a pipe joint 701 according to one embodiment of the present application. An opening 705 shown in FIG. 7E is a hexagonal opening, so that the opening 705 can match a limiting portion with a hexagonal peripheral contour corresponding to the pipe joint 701, to restrain the pipe joint 701 from rotating around its own axis.

Through the description of the above implementations, a person skilled in the art can clearly understand that, for convenience and conciseness of the description, the division of the above portions, structures, or components is only an example. In practical applications, the components or assemblies can be divided into different portions, structures, or components according to specific needs, and all different division modes fall within the scope of protection of the present invention.

A person of ordinary skill in the art can understand and implement other changes to the disclosed implementations by studying this specification, the disclosed content, the accompanying drawings, and the attached claims. In the claims, the term “include” does not exclude other elements and steps, and the term “a/an” and “one” do not exclude the plural. In the practical application of the present application, a part may perform the functions of multiple technical features referenced in the claims. Any reference numerals in the claims should not be construed as limiting the scope.

What is claimed is:

1. A pipe joint adapted to be riveted to a member to be riveted, comprising:
a main body having a through hole extending therethrough, and the main body comprises:
a connecting portion, wherein the connecting portion comprises a proximal end for connecting a pipeline and a distal end relatively away from the proximal end;
a deformable portion, a proximal end of which is connected to the distal end of the connecting portion, wherein an outer diameter of the distal end of the connecting portion is greater than an outer diameter of the deformable portion, and the deformable portion is configured to protrude radially outwards under an external force, to cooperate with the distal end of the connecting portion to clamp the member to be riveted; and
a limiting portion, wherein the connecting portion is connected to the deformable portion through the limiting portion, an outer diameter of the limiting portion is greater than the outer diameter of the deformable portion and less than the outer diameter of the distal end of the connecting portion, and the limiting portion is configured such that, when the deformable portion is inserted into an opening of the member to be riveted during riveting the pipe joint to the member to be riveted, the limiting portion abuts against the opening to restrain the pipe joint from rotating around an axis extending along the through hole of the pipe joint.

2. The pipe joint according to claim 1, wherein a peripheral contour of the limiting portion is non-circular.

3. The pipe joint according to claim 2, wherein the peripheral contour of the limiting portion is polygonal.

4. The pipe joint according to claim 1, wherein at least one protrusion is arranged on a peripheral surface of the limiting portion.

5. The pipe joint according to claim 1, wherein a surface structure for enhancing a frictional force is arranged on a peripheral surface of the limiting portion.

6. The pipe joint according to claim 5, wherein the surface structure for enhancing the frictional force comprises a knurled structure.

7. The pipe joint according to claim 1, wherein a groove for receiving a sealing element is provided in an outer end surface of the distal end of the connecting portion, the groove being arranged around a periphery of the deformable portion.

8. The pipe joint according to claim 1, wherein a surface structure for enhancing a frictional force is arranged on an outer end surface of the distal end of the connecting portion.

9. The pipe joint according to claim 8, wherein the surface structure for enhancing the frictional force comprises at least one protrusion.

10. The pipe joint according to claim 1, wherein a transition slope is formed between the connecting portion and the limiting portion, and the transition slope forms an angle of 30 to 60 degrees with the axis extending along the through hole.

11. The pipe joint according to claim 1, wherein the through hole is at least partially provided with an internal thread at the connecting portion.

12. The pipe joint according to claim 1, wherein the main body further comprises a pulling riveting portion; a proximal end of the pulling riveting portion is connected to the distal end of the deformable portion; and the through hole is at least partially provided with an internal thread at the pulling riveting portion for being engaged with a riveting tool.

13. The pipe joint according to claim 12, wherein a diameter of the through hole at the pulling riveting portion is less than a diameter at the connecting portion and a diameter at the deformable portion.

14. The pipe joint according to claim 12, wherein the deformable portion is connected to the pulling riveting portion through a breakable portion, and the breakable portion is easy to beak under external force, thereby separating the pulling riveting portion from the pipe joint.

15. The pipe joint according to claim 14, wherein a wall thickness of the breakable portion is less than a wall thickness of the pulling riveting portion and a wall thickness of the deformable portion.

16. The pipe joint according to claim 14, wherein an outer diameter of the breakable portion is less than an outer diameter of the pulling riveting portion and the outer diameter of the deformable portion.

17. The pipe joint according to claim 14, wherein the breakable portion is a tapered transition structure arranged between the deformable portion and the pulling riveting portion.

18. The pipe joint according to claim 1, wherein the deformable portion is configured such that the distal end of the deformable portion folds radially outwards under an external force to cooperate with the distal end of the connecting portion to clamp the member to be riveted.

19. The pipe joint according to claim 1, wherein the distal end of the connecting portion has a flange structure.

20. A riveting assembly, comprising:
a member to be riveted, wherein the member to be riveted has a fluid channel, and at least one opening is formed in a pipe wall of the fluid channel; and
the pipe joint according to claim 1, wherein the deformable portion of the pipe joint is inserted into the fluid channel through the opening and radially outwards protrudes under an external force to cooperate with a distal end of the connecting portion to clamp the pipe wall of the fluid channel, thereby fixing the pipe joint to the member to be riveted.

21. The riveting assembly according to claim 20, wherein the limiting portion abuts against the opening to restrain the pipe joint from rotating around the axis extending along the through hole of the pipe joint.

22. The riveting assembly according to claim 20, wherein the distal end of the deformable portion is radially outwards folded and cooperates with the distal end of the connecting portion to clamp the pipe wall of the member to be riveted.

23. A mounting method for mounting the pipe joint according to claim 1 to a member to be riveted, comprising:
providing a member to be riveted, wherein the member to be riveted has a fluid channel, and at least one opening is formed in a pipe wall of the fluid channel;
inserting the deformable portion of the pipe joint into the fluid channel through the opening, and causing the limiting portion to abut against the opening; and
applying a force to the deformable portion, thereby causing the deformable portion to radially outwards protrude to cooperate with a distal end of the connecting portion to clamp the pipe wall of the fluid channel.

24. The method according to claim 23, wherein the fluid channel of the member to be riveted comprises a cylindrical pipe wall, and the method further comprises: applying a pressure to the pipe wall close to the opening by using a pressing head, to form a relatively flat mounting region close to the opening.

25. The method according to claim 24, wherein the pressing head has a flat portion and a slope portion; and the applying a pressure to the pipe wall close to the opening by using a pressing head, to form a relatively flat mounting region close to the opening comprises: applying a pressure to the pipe wall close to the opening by using the flat portion, to form the relatively flat mounting region close to the opening, and applying, by using the slope portion, a pressure to the pipe wall that is close to the relatively flat mounting region in a fluid flowing direction of the fluid channel, to form a flow guiding region with a slope.

26. The method according to claim 23, wherein the applying a force to the deformable portion, thereby causing the deformable portion to radially outwards protrude to cooperate with the distal end of the connecting portion to clamp the pipe wall of the fluid channel comprises:
applying the force to the deformable portion, thereby causing a distal end of the deformable portion to fold radially outwards to cooperate with the distal end of the connecting portion to clamp the member to be riveted.

27. The method according to claim 23, wherein the pipe joint further comprises a pulling riveting portion; a proximal end of the pulling riveting portion is connected to a distal end of the deformable portion, and at the pulling riveting portion, the through hole is at least partially provided with an internal thread for being engaged with a riveting tool; the applying a force to the deformable portion, thereby causing the deformable portion to radially outwards protrude to cooperate with the distal end of the connecting portion to clamp the pipe wall of the fluid channel comprises: causing the riveting tool to pass through the through hole of the main body and engaging the riveting tool with the internal thread at the pulling riveting portion; and rotating the riveting tool to move the pulling riveting portion towards the deformable portion, thereby causing the deformable portion to radially outwards protrude to cooperate with the distal end of the connecting portion to clamp the pipe wall of the fluid channel.

28. The method according to claim 23, wherein the applying a force to the deformable portion, thereby causing the deformable portion to radially outwards protrude to cooperate with the distal end of the connecting portion to clamp the pipe wall of the fluid channel comprises:
causing an expandable head end of a riveting tool to pass through the through hole of the main body; expanding the head end of the riveting tool; and
moving the riveting tool towards the connecting portion to drive, through the head end of the riveting tool, the deformable portion to move towards the connecting portion, thereby causing the deformable portion to radially outwards protrude to cooperate with the distal end of the connecting portion to clamp the pipe wall of the fluid channel.
